(19) United States
(12) Patent Application Publication
(10) Pub. No.: US 2008/0011068 A1
(43) Pub. Date: Jan. 17, 2008

(54) Apparatus and method of making and using the apparatus for adjusting engine valves

(76) Inventor: Richard Lee Lewis, Buena Park, CA (US)

Correspondence Address: PATENT LAW & VENTURE GROUP, 2424 S.E. BRISTOL, SUITE 300, NEWPORT BEACH, CA, 92660, US

(21) Appl. No.: 11/486,604

(22) Filed: Jul. 14, 2006

(51) Int. Cl. G01M 15/00

(52) U.S. Cl. 73/116

(57) ABSTRACT

Described is a method of making and using an adherent indicia strip on a crankshaft pulley of a piston engine to adjust engine valves. The method includes cutting the strip to a length sufficient to exactly encircle the crankshaft pulley; placing midpoint marks onto a visible outside surface of the strip; engaging the strip with a peripheral edge of the crankshaft pulley while aligning the strip for corresponding rotational positions of the crankshaft pulley; and guiding rotation and positioning of the crankshaft and camshaft by the midpoint marks on the indicia strip in order to more easily and accurately adjust the engine's valves.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to strips for adjusting the valves of an internal combustion engine, and more particularly to a magnetic or otherwise adherent indicia strip mountable onto a crankshaft pulley for visual positioning of the crankshaft for adjusting the engine's valves.

2. Description of Related Art Including Information Disclosed Under 37 CFR 1.97 and 1.98

Hash, U.S. Pat. No. 1,609,714, discloses a piston gauge for valve timing comprising an elongated body member having a tubular guide projecting at right angles and at one end, a mounting screw operating through the guide, and a spring controlled calibrated slide shiftable through the opposite end of the body at right angles.

Worel, U.S. Pat. No. 2,511,392, discloses an electrical instrument for determining top dead center position of a piston-type engine, comprising an upstanding mounting adapted to be secured to the top of an engine adjacent one of the pistons, a rod slidably accommodated in the mounting for movement by actuation of the piston in a path substantially normal to the top of the piston, the rod having a depending electrical contact at the lower portion thereof, disposed in the path of the head of the piton, an electrical signal device deposed above the mounting and having one of its terminals electrically connected with the contact, means for connection of the other terminal of the signal with a source of electromotive forces grounded to the piston and means for retaining the rod in the topmost position to which it is raised by the upward movement of the piston.

Smith, U.S. Pat. No. 1,786,034, discloses an indicator comprising a rotatably mounted dial bearing indicia denoting the firing order of an internal combustion engine, indicating means coacting with the indicia, and electromechanical means for electrical connection to the ignition system of the engine and adapted to operate the dial to successively bring its indicia into register with the indicating means.

Schoenleber, U.S. Pat. No. 2,837,713, discloses a means for timing the ignition in an internal combustion engine of the type having a fan belt pulley adapted to be moved in synchronism with the crank shaft, a pointer carried by the pulley and formed of conducting material, a dial of conducting material carried adjacent the pulley and in close proximity to the path of travel of the pointer, the dial being insulated from the engine and the pulley and having an indexing mark, adapted to coincide with the pointer when a piston of the engine is at top dead center, and an electrical connection between the ignition system and the dial for electrifying the dial when a spark would normally occur with respect to the top dead center, piston so that a spark occurs between the dial and the pointer, enabling thereby the advance or retard of the spark to be observed in the relationship to the indexing mark while the engine is running.

Mehl, U.S. Pat. No. 3,724,083, discloses an instrument comprising two or more elongated flexible strips of plastic having magnetic properties such that when the strips are in the first position relative to one another, they overlap their full widths and cling-together to form a multiple thickness assembly; and in a second position with the ends of one strip reversed relative to the other, they overlap only half widths. In the first position, the strips form a laminated flexible drafting spline which adheres to a sheet-steel-faced board underlying a sheet of drawing paper. There are measurement graduations and indicia along the edges and the two overlapping strips can be slipped endwise with respect to one another to form an extensible measuring tape for measuring distances along curved lines. Strips with logarithmic graduations can be used in the second position to form a slide rule.

Shultz, Jr., U.S. Pat. No. 4,291,467, discloses a guide rule for aligning and facilitating mounting of a protective side molding to a side panel of a vehicle, with the side molding in a substantially straight line orientation. The guide rule includes a continuous elongated strip of flexible magnetic material, preferably of the type having a plurality of magnetized particles embedded in or impregnated in an elastomeric material.

Ansteth, U.S. Pat. No. 4,580,446, discloses an improved degree wheel which is adjustably rotatable relative to the crankshaft on which it is carried. The wheel can be easily adjusted so that a zero degree reading corresponds to top dead center of piston travel. Much of the calculation necessary to determine cam phasing, cam lobe centerline, valve overlap, and the like is thereby eliminated. The degree wheel preferably includes counterclockwise 0-360 degree indicia for a direct and calculation-free determination of the duration of tappet lift.

Yukoyama et al., U.S. Pat. No. 4,810,967, discloses a light, compact angle-of-rotation sensor that is comprised of a magnetic ring bonded to a shaft by means of resin. The magnetic ring is provided around its periphery with a number of magnetized zones, with each such magnetized zone having a different number of magnetic poles, and magnetic interference between magnetized zones is prevented by leaving non-magnetized spaces between the magnetized zones. The prevention of magnetic interference can be further enhanced by the provision of non-magnetized portions between the magnetic poles of the magnetized zones.

Boaze, Sr., U.S. Pat. No. 5,105,155, discloses an apparatus for setting the spark timing of an internal combustion engine comprising a pointer element removably attachable to rotor of a distributor with its cap removed and a scale element removably attachable to the exterior of the distributor housing in cooperative relationship with said pointer element to indicate the time of ignition spark impulse to an engine cylinder relative to the piston position in said cylinder.

The related art described above discloses ways and means for more easily making adjustments to the valves of a piston engine. However, the prior art fails to disclose an adherent strip for attachment to a crankshaft pulley, the strip having markings for visual alignment of the several cams of the engine for improved valve adjustment. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

The present invention is a method of making and using an adherent indicia strip on a crankshaft pulley of an engine to adjust engine valves. The method includes cutting the strip to a length sufficient to exactly encircle the crankshaft pulley; placing midpoint marks onto a visible outside surface of the strip; engaging the strip with a peripheral edge of the crankshaft pulley while aligning the midpoint marks with corresponding rotational positions of the crankshaft pulley; and guiding rotation and positioning of the crankshaft and camshaft by the midpoint marks on the indicia strip in order to more easily and accurately adjust the engine's valves.

A primary objective inherent in the above described apparatus and method of use is to provide advantages not taught by the prior art.

Another objective is to provide a strip for visual positioning of an engine crankshaft and camshaft for valve adjustment.

A further objective is to provide such a strip that is magnetically engaged and disengaged with a crankshaft pulley.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus as mounted onto a crankshaft pulley of a piston engine;

FIG. 2 is a partial perspective view thereof;

FIG. 3 is a plan view of alternate embodiments thereof for use with specific engines each having distinctive characteristics including number of cylinders and size of crankshaft pulley; and

FIG. 4 is an end view of a set of the intake and exhaust lobes for a piston engine.

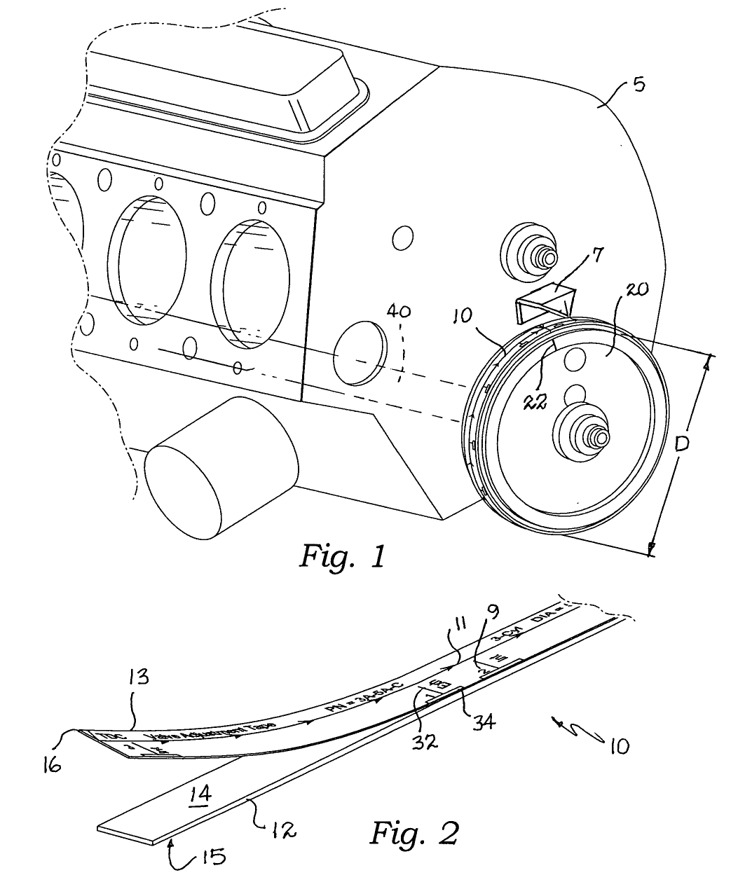

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

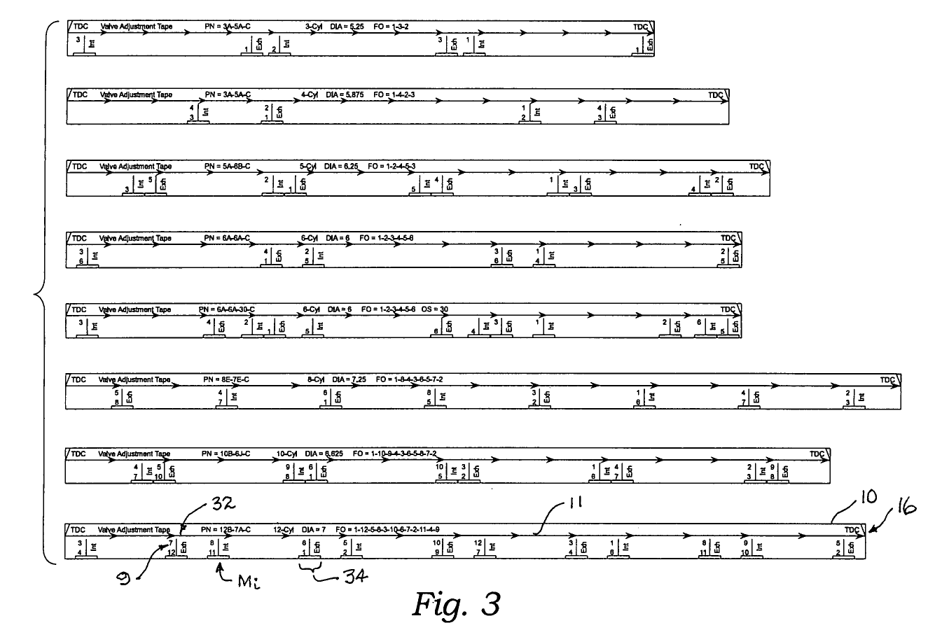

Described now in detail is an apparatus and method of making and using said apparatus for adjusting the valves of an internal combustion engine 5. The apparatus described herein is preferably an indicia strip 10 with visible markings on one. In the following description it will be assumed that the strip 10 is magnetic and is therefore able to adhere to an iron containing crankshaft pulley 20 by magnetic attraction, but the strip 10 may also be non-magnetic and it may be attached to the pulley 20 by other means such as by bonding agents and the like. The strip 10, in one embodiment or another, as shown in FIG. 3, may be used with most internal combustion engines and it allows the user to quickly and accurately locate the preferred rotational positions of the midpoint of the lobes (intake 30′ and exhaust 30″) on the camshaft 35 of the engine for properly adjusting the engine's intake and exhaust values. When the engines crankshaft 40 is manually rotated, the strip 10 identifies which intake and exhaust valves should be adjusted at each rotational midpoint marking on the strip 10. The strip 10 is preferably made from a flexible magnetic sheet material and is formed as a long bottom layer 12 with a top layer 13 of vinyl, for instance, or a vinyl coating bonded or otherwise joined to a surface 14 of the bottom layer 12. Preferably, the strip 10 is ¾ inch wide and about 0.020 inches in thickness to provide good flexibility with relatively low shape memory. Its length depends on the size of the crankshaft pulley 20 to which it is mounted. The strip 10 indicates the exact rotational position between the intake 30′ and corresponding exhaust 30″ camshaft lobe centerlines, e.g. the midpoints 32. Once the position of each midpoint 32 for each cylinder has been established, the appropriate intake and corresponding exhaust valves can be adjusted to manufacturer's specification.

The strip 10 may be used on any engine that has a crankshaft, a camshaft and a pulley 20 connected together directly or indirectly. However, every engine has different specifications regarding the number of cylinders, the timing of the camshaft intake and exhaust lobes, the diameter of pulley 20, and crankshaft offset. Therefore, the strip 10 may have any one of a range of length dimensions and indicia appropriate to each specific engine as shown in FIG. 3. The strip 10 is used with the engine off where pulley 20, crankshaft 40, timing chain and gears connecting to the camshaft 35 are all rotated manually at the same time. It is noted that the pulley 20 has several other names in the industry such as; vibration damper, harmonic balancer, torsional damper, and torsional vibration absorber. Some engines do not use a harmonic damper, however, almost all engines use a pulley 20 on the crankshaft and it is the pulley 20 that is necessary in order to use the strip 10. The term “pulley” will be used in the following description and this represents harmonic dampers as well.

Preparation of the presently described strip 10 requires five items of information related to the specific engine that the strip 10 will be used with, as follows:
1. The firing order of the engine 5; for example, 1-8-4-3-6-5-7-2, which also yields the number of cylinders.
2. The outer diameter of the pulley 20; for example, 7.25 inches.
3. The #1 cylinder intake lobe centerline “Toe” value of the camshaft being used, measured in crankshaft degrees; for example 1080 after top dead center (ATDC).
4. The lobe separation value of the camshaft being used, measured in crankshaft degrees which relates to the angle between each intake and corresponding exhaust lobe; for example, 112°.
5. The crankshaft offset value, if any, which relates to alternating degree intervals between cylinder firings; for example, on an 8-cylinder engine, the degree interval is evenly set at 90°, but with a 30° offset, it would yield alternating degree intervals of 120°/60°/120°/60° and so on, starting with the next cylinder after the #1 cylinder.

The length (L) of strip 10 is calculated from the known circumference of the pulley 10 as follows.
L=π(D+1.47K) where

D is the diameter of the pulley 20, K equals the thickness of the strip 12, and 1.47 is an experimentally determined strip bend factor.

A firing sequence angle A_{c} is defined as the number of degrees of rotation of the crankshaft 40 between adjacently fired cylinders of the engine 5, and is calculated as follows:
A_{c}=720°/C

where C is the number of cylinders in the engine.

Once the value for crankshaft's rotational position for the #1 cylinder intake lobe centerline has been obtained and A_{c} calculated, the rotational positions of all of the other intake lobe centerlines is determined by adding A_{c} to each previous position. Therefore, each successive intake lobe centerline is calculated as follows:
Nₓ=N_{y}+A_{c}+F

where

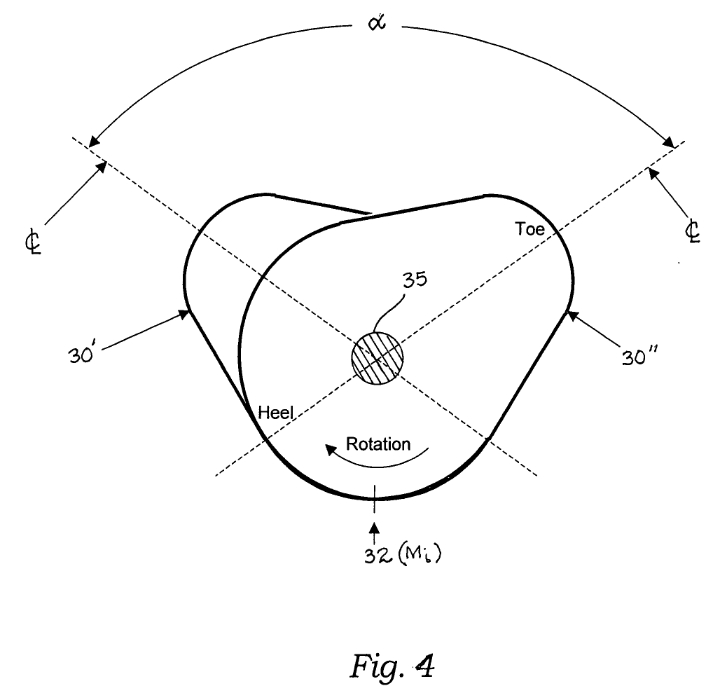

Nₓ is the next valve's angular position, NY is the preceding valve's angular position, and F is the crankshaft offset angle (if applicable). The values of N, relate to the toes of the intake cams as shown in FIG. 4. The heels (see FIG. 4) of the intake cams 30′ are positioned 180° away from the respective toes, or 360° of the crankshaft rotation.

Lobe separation angles are measured in camshaft degrees rather than crankshaft degrees as calculated above. Conversion is as follows:

S=2 R where S is in crankshaft degrees and R is in camshaft degrees, in other words, the camshaft rotates once while the crankshaft rotated twice.

Once all intake lobe heel positions have been calculated, midpoints are defined as the exact center between the values of the intake 30′ and corresponding exhaust 30″ lobe's heel positions. Using the lobe separation angle α, see FIG. 4, and the intake heel centerlines, the midpoints 32 (Mᵢ) are calculated as follows:
Mᵢ=Nᵢ−(S/2)

where Nᵢ is the heel position and i is the cylinder number.

Once the midpoint values are calculated, they are sorted from lowest to highest angular values. This list indicates the exact order for which each midpoint 32 is approached as the crankshaft 40 is rotated from 0° to 720° (two revolutions). It is pointed out that in a four-cycle internal combustion engine, the crankshaft 40 must make two full rotations to move through the engine's four cycles with intake and compression strokes on the first rotation, and power and exhaust strokes on the second rotation. However, the strip 10 is wrapped around the circumference of the pulley 20 only once. Therefore, it is marked to show positions of the midpoints 32 for all of the intake valves between 0° to 720°. For midpoints 32 that have angles greater then 360°, 360° is subtracted so that all midpoint values Mᵢ are in the range of 0° to 360° (one revolution).

In labeling the strip 10 each midpoint position is marked by converting its angular position to a linear dimension measured from the mark for TDC as follows:

V_{cm}=D_{cm} L/360 where V_{cm} represents linear measurement, D_{cm} represents the respective angular measurement of each midpoint and L is the length of the strip 10 as discussed above. Clearly, a mark for a midpoint 32 on the first revolution of the crankshaft may be in the same location on strip 10 as a mark on the second revolution.

Although, the marks 32 represent the exact position of the midpoints, it is sometimes difficult to align these marks exactly to the engine timing pointer 7 which is physically attached to the engine 5. This is due to a number of factors such as mass, friction, and compression of the crankshaft, its bearings, connecting rods, pistons, and piston rings, as well as the timing chain, camshaft, lifters, push-rods, rocker arms, valves, and valve springs. Therefore, an indicia (rectangle or broader mark shown in FIG. 3) to indicate an acceptable range 34 is provided. Preferably, the width of each rectangle is approximately 7 crankshaft degrees to the left and to the right of each central mark Mᵢ so that alignment of the timing pointer 7 anywhere on the rectangle's range 34 is acceptable.

The strips 10 shown in FIG. 3 are, from top of FIG. 3 to the bottom of FIG. 3, are used on: a 3-cylinder engine with a pulley 20 of 5.25 inches in diameter and a firing order of 1-3-2 and no crankshaft offset, a 4-cylinder engine with a pulley 20 of 5.875 inches in diameter and a firing order of 1-4-2-3 with no crankshaft offset, a 5-cylinder engine with a harmonic damper or pulley of 6.25 inches in diameter and a firing order of 1-2-4-5-3 and no crankshaft offset, a 6-cylinder engine with a pulley 6 inches in diameter and a firing order of 1-2-3-4-5-6 and no crankshaft offset, a 6-cylinder engine with a pulley 6 inches in diameter and a firing order of 1-2-3-4-5-6 and a crankshaft offset of 300, an 8-cylinder engine with a pulley 7.25 inches in diameter and a firing order of 1-8-4-3-6-5-7-2 with no crankshaft offset, a 10-cylinder engine with a pulley of 6.625 inches in diameter and a firing order of 1-10-9-4-3-6-5-8-7-2 with no crankshaft offset, and a 12-cylinder engine with a pulley 7 inches in diameter and a firing order of 1-12-5-8-3-10-6-7-2-11-4-9 with no crankshaft offset.

While facing the front of the engine, the strip 10 is attached to the outer circumference of the pulley 20 such that the ends of the strip 10 meet each other at the top dead center (TDC or 0°) timing mark 22 on the pulley 20 making sure that the strip 10 is readable from the front of the engine and not upside down. Next, the crankshaft is rotated in the direction shown by the in-line horizontal arrow or arrows until the TDC mark of the strip 10 is aligned or closely aligned with the engine timing pointer 7. This establishes a reference point. Next, continue to manually rotate the crankshaft 40 in the same direction until the engine pointer 7 indicates the first midpoint mark 32 with its cylinder number and adjust the respective valves.

Next, check the lifters of engine 5 for the cylinders represented by the numerals 9 on the strip 10. Where the marks 9 represent two cylinders, only the lifters for one cylinder should be low and the others should be high snug. The low ones are the valves that need to be adjusted because this is the location of the midpoint. If the numerals have been color coded or otherwise indicated as to first versus second revolution, then it is clear which ones need to be tightened during each respective rotation of the crankshaft. Continue to manually rotate the crankshaft 40 in the same direction adjusting all the valves on the first revolution until reaching the TDC, then adjust the remaining valves using the same procedure on the second revolution.

Once reaching the TDC mark on the second revolution, all of the valves in the engine have been adjusted. The strip 10 may be easily manually stripped off the pulley 10 and held for further use on another engine.

To summarize, the present invention is a method of making and using a strip 10 on a pulley 20 of an engine crankshaft 40 to adjust engine valves. The method comprises the steps of forming a flexible strip 12 from a sheet of flexible material, the flexible strip 12 having a length sufficient to exactly encircle the crankshaft pulley 20. Next, midpoint marks 32 are placed on an outside surface 14 of the flexible strip 12 and then the strip 10 is engaged at its inside surface 15 with a peripheral edge 22 of the crankshaft pulley 20 so that the midpoint marks 32 are aligned with corresponding rotational positions of the crankshaft pulley 20; and positioning the crankshaft 40 by the midpoint marks 32 on the strip 10 to position the crankshaft 40 for adjusting the engine valves. The method further includes the step of placing the midpoint marks 32 along the magnetic strip by determining: a cylinder firing order; an outside diameter of the crankshaft pulley; an angular spacing for cylinder number one between TDC and a centerline of an intake lobe 30′; a lobe separation angle, alpha; and a crankshaft offset value. Further, the method comprises the step of placing an arrow 11 or other mark on the outside surface of the strip 10, the arrow 11 positioned for indicating a direction of rotation of the crankshaft pulley 20 during engine valve adjustment.

The method further comprises the step of placing further marks on the strip 10 including: a TDC mark 16, midpoint marks 32 and tolerance span marks 34, the midpoint marks 32 aligned laterally and numerals 9 corresponding to cylinder numbers adjacent to the midpoint marks 32.

The method further comprises placement of the strip 10 onto the crankshaft pulley 20 while aligning the TDC mark 16 of the strip 10 with a TDC indicator 22 on the crankshaft pulley 20.

The method further comprises the steps of: rotating the crankshaft 40 in the rotational direction indicated by the arrow 11 to align each midpoint mark 32 in turn with the engine pointer 7; and in turn, adjusting the engine valves of the engine cylinders indicated by the numerals 9 on the strip 10.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. (canceled)

2. (canceled)

3. The method of claim 10 further comprising the steps of determining:
a) a cylinder firing order;
b) an outside diameter of the crankshaft pulley;
c) an angular spacing for cylinder number one between a TDC mark and a centerline of an intake lobe;
d) a lobe separation angle; and
e) a crankshaft offset value.

4. The method of claim 10 further comprising the step of placing an arrow on the outside surface of the indicia strip, the arrow positioned for indicating a direction of rotation of the crankshaft pulley during engine valve adjustment.

5. The method of claim 10 further comprising the step of placing a top dead center mark on the outside surface of the indicia strip.

6. The method of claim 5 further comprising the step of placing tolerance span marks on the outside surface of the indicia strip.

7. (canceled)

8. The method of claim 3 wherein the placement of the indicia strip onto the crankshaft pulley further comprises the step of aligning the top dead center mark of the indicia strip with a top dead center indicator on the crankshaft pulley.

9. (canceled)

10. A method of making and using an indicia strip on a pulley of an engine crankshaft to adjust engine valves of engine cylinders, the engine cylinders referenced by cylinder number, the method comprising the steps of:
a) engaging the indicia strip on a peripheral edge of the pulley;
b) placing a mark on the indicia strip for each rotational position of the pulley where a valve adjustment can be made;
c) placing a pair of cylinder numbers on the indicia strip adjacent to each said mark, a first one of each pair of cylinder numbers corresponding to an intake valve of the respective one of the engine cylinders; and a second one of the pair of cylinder numbers corresponding to an exhaust valve of the respective one of the engine cylinders;
d)
e) rotating the pulley to align each said mark, in turn, with an engine reference pointer, over a first full rotation of the pulley, thereby positioning an intake camshaft lobe of each of the engine cylinders associated with the first one of the pair of cylinder numbers, in turn, for adjustment;
f) rotating the pulley to again align each said mark, in turn, with the engine reference pointer, over a second full rotation of the pulley, thereby positioning an exhaust camshaft lobe of each of the engine cylinders associated with the second one of the pair of cylinder numbers corresponding to said marks, in turn, for adjustment; and
g) adjusting the engine intake and exhaust valves of each of the engine cylinders.
